(19) United States
(12) Patent Application Publication
(10) Pub. No.: US 2013/0059125 A1
(43) Pub. Date: Mar. 7, 2013

(54) MANUFACTURING APPARATUS AND MANUFACTURING METHOD OF COMPOSITE STRUCTURAL MEMBER

(71) Applicants: Takayuki HOSHINO, Tochigi (JP); Yosuke IKADAI, Tochigi (JP); Tomohiko SHIGIHARA, Tochigi (JP)

(72) Inventors: Takayuki HOSHINO, Tochigi (JP); Yosuke IKADAI, Tochigi (JP); Tomohiko SHIGIHARA, Tochigi (JP)

(73) Assignee: HONDA MOTOR CO., LTD., Tokyo (JP)

(21) Appl. No.: 13/587,568

(22) Filed: Aug. 16, 2012

(30) Foreign Application Priority Data
Sep. 1, 2011 (JP) 2011-190414
Feb. 6, 2012 (JP) 2012-023120
Apr. 26, 2012 (JP) 2012-101639

(51) Int. Cl. B32B 37/06; B32B 38/04; B32B 7/04; B32B 37/10

(52) U.S. Cl. 428/172; 156/499; 156/379.6; 156/264

(57) ABSTRACT

A composite structural member made of a plate and a thermoplastic resin reinforcing member is manufactured by: continuously supplying the reinforcing member; cutting the reinforcing member; heating the reinforcing member; and pressing the heated reinforcing member to the plate.

### BACKGROUND OF THE INVENTION

1. Field of the Invention

The present invention relates to a manufacturing apparatus and a manufacturing method of a composite structural member and a composite structural member.

2. Related Art

Patent Document 1 (JP-A-2011-016275) discloses a laminated structure which is used in a fender or a roof of a vehicle and made of a metal panel and a resin rib to ensure a rigidity of the metal panel.

In an apparatus for manufacturing the laminated structure disclosed in Patent Document 1, a rib is formed by discharging resin on a back side of a heated plate through a resin discharging part and pressing the discharged resin on the plate by a forming roller.

In the apparatus disclosed in Patent Document 1, since it is necessary to mold the resin for forming the rib, when a shape of resin material becomes complex, a configuration of the apparatus should also become complex. As a result, there is a problem that a molding speed becomes slow. Further, according to this apparatus, since a heated plate is transferred to a rib forming process by a transfer robot, there is a risk that a temperature of the plate is lowered during the transfer and thus adhesion defect of the resin occurs.

Meanwhile, since the resin rib is expanded by heating and contracted during cooling, there is a problem that deformation occurs in the surface of the metal panel. As the deformation occurs, an external appearance quality of the metal panel is significantly reduced. Accordingly, suppression of the deformation is strongly demanded.

Patent Document 2 (JP-A-2007-296875) and Patent Document 3 (JP-A-59-209852) disclose a technology in which a flexible layer that is made of a thermoplastic urethane resin as a base material is provided between a metal panel and a thermosetting resin rib. According to this technology, owing to the flexible layer having flexibility, it is possible to suppress deformation of the metal panel due to contraction of the resin rib.

However, in the technology disclosed in Patent Documents 2 and 3, since a thermosetting resin is used as the resin rib, handling at the time of molding is difficult. Further, in a case where the metal panel is used for a door panel or a quarter panel of a vehicle, a painting of the metal panel is implemented after the metal panel is reinforced with the resin member. In this painting process, the metal panel is heated for baking paints. In the structure of Patent Documents 2 and 3, owing to heating for baking paints, the thermosetting resin rib is hardened but the thermoplastic resin flexible layer is softened. Accordingly, (tensile) load occurs in a joint interface of the strength layer and the flexible layer and therefore the strength layer and flexible layer are easily decoupled from each other.

Meanwhile, Patent Document 4 (JP-A-2007-007894) discloses an induction heating apparatus for heating a metal member.

The induction heating apparatus is an apparatus which induces a current to a body (hereinafter, referred to as “heated body”) to be heated by electromagnetic induction to heat the body. According to the structure of Patent Document 4, the axis of a coil is arranged in perpendicular to the heated body.

In the induction heating apparatus, since magnetic flux lines are substantially perpendicular to the heated body and an induced current is generated at the heated body in a periphery of a coil along the magnetic flux lines, a periphery of the coil becomes high-temperature.

Therefore, since a temperature difference between a heated part and a non-heated part is large, there is a problem that thermal strain occurs due to thermal expansion.

In particularly, when a thin steel plate is heated by induction heating, the steel plate is locally heated depending on a diameter of the coil. Accordingly, a temperature difference between a heated area and a cold area becomes significantly large and thus the heated area is locally subjected to thermal expansion. Thereby, a strain occurs in the steel plate by heating. Further, in a case where a thermoplastic resin is fused on the thin metal plate, deformation such as wrinkles occurs. Accordingly, it is difficult to fuse the thermoplastic resin on the thin metal plate.

### SUMMARY OF THE INVENTION

One or more embodiments relate to an apparatus and a method which are capable of manufacturing a complex structural member in a speedy manner by a simple mechanism, even when a reinforced member having a complex configuration is utilized.

### BRIEF DESCRIPTION OF THE DRAWINGS

FIG. 1 is a view illustrating a reinforcement apparatus of a first embodiment.

FIG. 2 is a schematic view illustrating an example of a weld-adhesive resin.

FIG. 3 is view illustrating a warm air heating guide.

FIG. 4 is a view illustrating a pressing roller having L-guide.

FIG. 5 is a view illustrating a reinforcement apparatus of a second embodiment.

FIG. 6 is a view illustrating an induction heating apparatus.

FIG. 7 is a view illustrating a configuration of a composite structural member of a third embodiment.

FIG. 8 (a) is a sectional view of a resin member of the third embodiment and FIG. 8 (b) is a sectional view of a resin member of a modified embodiment.

FIG. 9 is a view illustrating a method of peel test (according to JISK6854) according to the third embodiment.

FIG. 10 is a sectional view of a resin member of a fourth embodiment.

FIG. 11 is a schematic view illustrating the shape of a coil in an induction heating apparatus of a fifth embodiment.

FIG. 12 is a schematic view illustrating the shape of a coil in an induction heating apparatus of a sixth embodiment.

FIG. 13 is a schematic view illustrating the shape of a coil in an induction heating apparatus of a seventh embodiment.

FIG. 14 is a schematic view illustrating the shape of a coil in an induction heating apparatus of an eighth embodiment.

FIG. 15 is a schematic view illustrating a thermoplastic resin reinforcement apparatus including an induction heating apparatus.

FIG. 16 is a schematic view illustrating a cut-away part of an induction heating apparatus.

FIG. 17 is a schematic view illustrating the shape of a coil in an induction heating apparatus of a related art.

### DETAILED DESCRIPTION OF THE EMBODIMENTS

### First Embodiment

FIG. 1 illustrates a manufacturing apparatus of a composite structural member according to a first embodiment.

A weld-adhesive resin 201 is utilized as a reinforcing member and prepared in a state where an elongated resin member is wound around a bobbin 202 in advance.

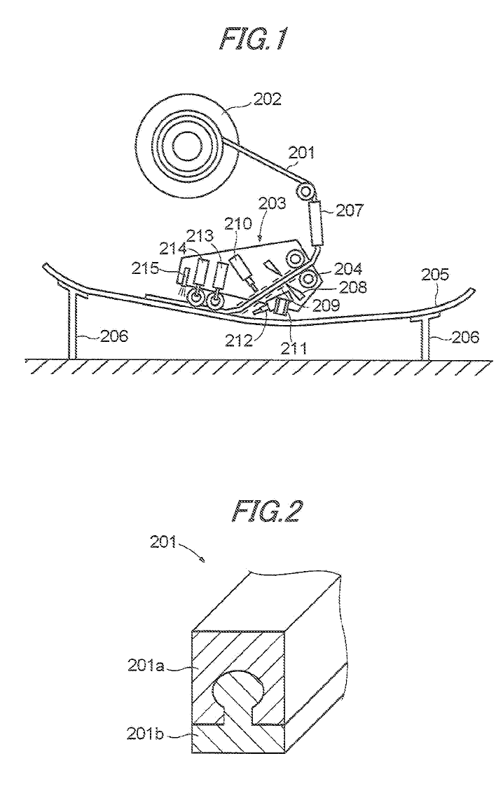

As the weld-adhesive resin 201, for example, as illustrated in FIG. 2, a material configured such that a flexible layer 201b is to be interlocking to a strength layer 201a is used. The strength layer 201a is made of a reinforced resin which consists of a mixture of a thermoplastic resin and a reinforcing agent. The flexible layer 201b is made of a thermoplastic resin which has flexibility higher than that of the strength layer. In this case, the contact area of the strength layer 201a and the flexible layer 201b increases, these layers are difficult to be decoupled from each other. Further, since both the strength layer 201a and the flexible layer 201b of the weld-adhesive resin 201 are made of a thermoplastic resin without using a thermosetting resin, handling at the time of molding is easy.

The weld-adhesive resin 201 is continuously fed by a feeding roller 204 within a weld-adhesion tool 203. The weld-adhesion tool 203 is coupled to a robot (not-illustrated) and adapted to move over a metal panel 205 as a plate which is reinforced by the weld-adhesive resin 201. That is, it is possible to reinforce any area on the metal panel 205 by the weld-adhesive resin 201 by moving the weld-adhesion tool 203 itself.

Further, the metal panel 205 is fixed by a fixing jig 206. The metal panel 205 fixed to the fixing jig 206 can move by moving the fixing jig 206. In this way, a positional relationship between the weld-adhesion tool 203 and the weld-adhesive resin 201 may be adjusted.

The weld-adhesive resin 201 may be preheated while being continuously fed before being inserted into the weld-adhesion tool 203. For example, in such a preheating, the weld-adhesive resin 201 is heated by constantly rising the ambient temperature in a heat-transfer heater tube 207 and passing the weld-adhesive resin 201 along the center of the heat-transfer heater tube 207 by a roller without being brought into contact with the tube wall of the heat-transfer heater tube 207.

The weld-adhesive resin 201 fed into the weld-adhesion tool 203 is cut to any length by a cutting part 208 and then inserted into a warm air heating guide 209 to be finally heated. The final heating is preferably performed by a hot-air generating device 210 since the surface of the resin material is abraded when rubbed on the tube wall of the heat-transfer heater tube.

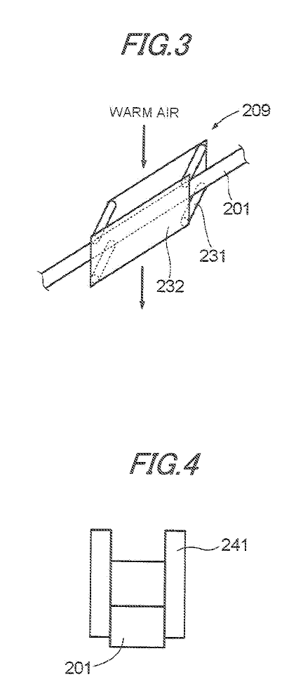

As illustrated in FIG. 3, the warm air heating guide 209 includes two sheets of side walls 232 which are supported by four supporting members 231, for example. The warm air heating guide 209 is configured to form a warm air inlet for introducing the warm air from the outside. Since the weld-adhesive resin 201 supported by the supporting members 231 is heated by the warm air while being fed along the interior of the warm air heating guide 209, it is possible to reduce the contact area with the surface of the weld-adhesive resin 201.

As indicated by arrow in FIG. 3, the weld-adhesive resin is finally heated by the warm air which is generated from the hot-air generating device provided over the warm air heating guide. In order to improve the shape following property, it is preferable that the final heating is performed by rapidly raising the temperature in a short time.

Meanwhile, the metal panel 205 is a member (hereinafter, referred to as a reinforced member) to be reinforced and a part of the metal panel on which resin is adhered is degreased and washed by atmospheric-pressure plasma generated by an atmospheric-pressure plasma generation device 211. By such a degreasing and washing operation, the weld-adhesive resin 201 is securely in close contact with the metal panel and therefore it is possible to suppress occurrence of an area to which the resin material is not adhered. Accordingly, adhesive force is enhanced and thus it is possible to perform stable adhesion.

Further, the temperature of the metal panel 205 is raised by a reinforced member heating unit 212. By such an operation, bonding force between the reinforcing member and the plate can be enhanced. As the reinforced member heating unit 212, a hot-air generating device may be employed, for example.

The weld-adhesive resin 201 which has been finally heated is pressed to the heated metal panel 204 by a pressing roller 213 having L-guide and also pressed by a pressing roller 214 having another L-guide. In this way, the weld-adhesive resin is cooled and solidified. As illustrated in FIG. 4, by utilizing the pressing rollers having a guide, it is possible to press the weld-adhesive resin while correcting the displacement of the resin material in a width direction.

Further, since it is possible to reduce tension which is caused in the contact surface of the strength layer 201a and the flexible layer 201b of the weld-adhesive resin 201 by being fixed by a guide 241, the stable adhesion with the metal surface can be achieved.

The weld-adhesive resin 201 is cooled and completely adhered to the metal panel 205 by blowing cooling air generated by a cooling air generating device 215 thereto in a state of being fixed by the pressing roller 214 having L-guide.

### Second Embodiment

FIG. 5 illustrates a manufacturing apparatus according to a second embodiment.

The heating method of the weld-adhesive resin 201 which is a reinforcing member is similar to the first embodiment. In a case where the metal panel 205 which is a reinforced member is a magnetic body such as an iron plate, an induction heating apparatus is employed as a reinforced member heating unit to perform induction heating.

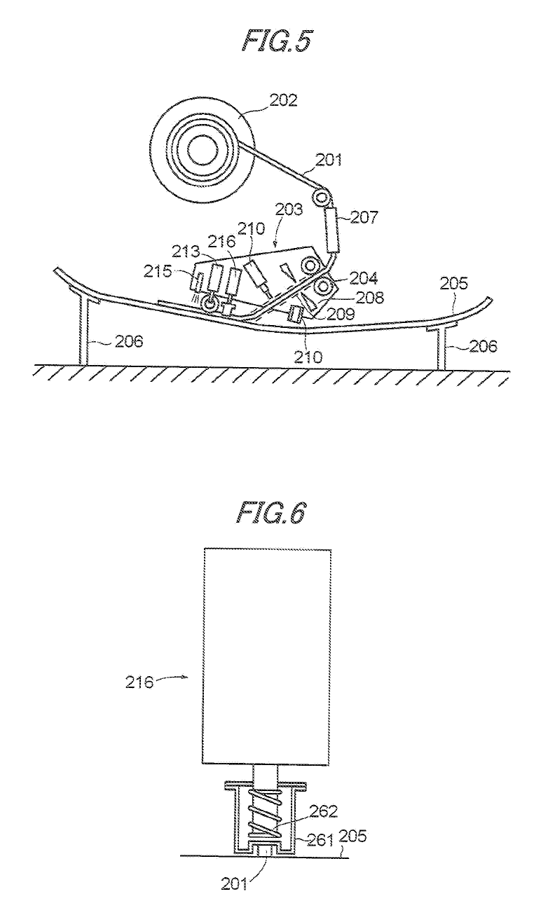

FIG. 6 illustrates the induction heating apparatus 216 and an adhesion state using the same. A coil 262 is provided in a pressing cover 261 of the induction heating apparatus 216 and current is supplied to the coil. By forming the pressing cover 261 from insulation material such as ceramic, resin or the like and performing a pressure control while heating only the surface of the metal panel 205 to which the weld-adhesive resin 201 is adhered by electromagnetic induction, the weld-adhesive resin 201 is adhered to the metal panel 205 while being positioned.

By heating and pressing the pressing cover 261 in a state of being pressed on the weld-adhesive resin 201, the relative distance between the coil 262 in the pressing cover 261 and the metal panel 205 can be constantly maintained without using a complex positioning device or an advanced control mechanism. Accordingly, the temperature of the metal panel 205 is uniformly raised and therefore it is possible to suppress adhesion defect with the weld-adhesive resin 201.

The induction heating apparatus 216 of the second embodiment is configured to simultaneously perform heating and pressing while guiding the weld-adhesive resin 201. Accordingly, since it is possible to effectively press the material while effectively heating only the metal member that is a magnetic body by performing induction heating, there is an advantage that bonding force with the reinforced member is enhanced.

### Third Embodiment

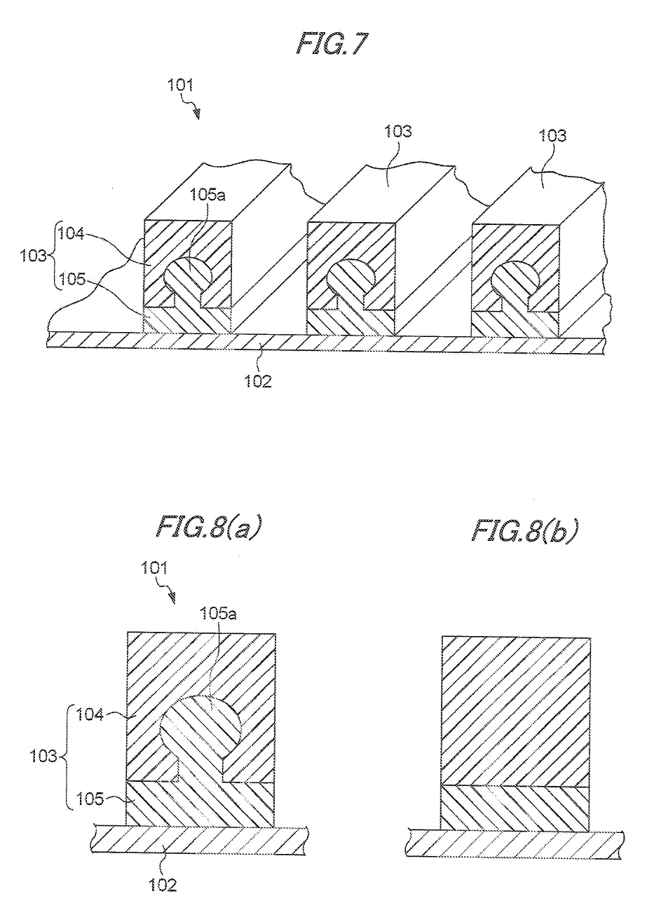

FIG. 7 is a view illustrating a configuration of a complex structural member 101 according to a third embodiment. The complex structural member 101 illustrated in FIG. 7 includes a metal panel 102 as a plate and a plurality of elongated resin members 103 (reinforcing member) which are adhered to the metal panel 102. The complex structural member 101 may be subjected to a heating process for baking of paint after formation.

As illustrated in FIG. 7, the metal panel 102 is a plate-shaped component which has a surface and a back surface. A plurality of resin members 103 are adhered to the back surface and the surface is constructed as a design surface which forms an outer appearance of a side panel such as a door panel or a quarter panel of a vehicle. Since the metal panel 102 is made of steel plate and formed in a thin plate from the viewpoint of improvement of formability and weight reduction, the bending rigidity of the metal panel becomes lower. Accordingly, a plurality of elongated resin members 103 are adhered to the back surface for reinforcement.

As illustrated in FIG. 7, the resin members 103 are elongated and arranged in parallel at a predetermined interval on the back surface of the metal panel 102. The resin member 103 include a strength layer 104 for reinforcement and a flexible layer 105 which is laminated and bonded to the strength layer 104 in a cross section perpendicular to the longitudinal direction thereof, as illustrated in FIG. 7, The flexible layer 105 is brought into contact with the metal panel 102 when the resin members 103 are adhered to the metal panel 102.

The strength layer 104 of the resin member 103 uses a thermoplastic resin [for example, a high-strength PA6 (nylon 6)] as a base material and is made of a glass fiber reinforced resin in which GF (glass fiber) is contained. For example, the content of GF in the strength layer 104 can be 20% by mass. The strength layer 104 of the resin member 103 may be made of a carbon fiber reinforced resin other than the glass fiber reinforced resin and may be made only of thermoplastic resin. The strength layer 104 mainly exhibits a function to reinforce the metal panel 102. Thereby, the composite structural member 101 formed by adhering the resin member 103 to the metal panel 102 has a high bending rigidity.

The flexible layer 105 of the resin member 103 uses a base material such as a thermoplastic elastomer. As the base material, a thermoplastic resin is used, which is more flexible than the strength layer 104 and has a high thermal conductivity. The flexible layer 105 has flexibility and exhibits a function to suppress deformation of the metal panel 102 mainly due to shrinkage (warpage) of the strength layer 104. As illustrated in FIG. 7, a center portion 105a of the flexible layer 105 is formed in a dovetail shape which is interlocking into the strength layer 104 in a cross section perpendicular to the longitudinal direction of the resin member 103. The interlocking portion (center portion of the flexible layer) 105a is difficult to be detached from the as strength layer after an interlocking. The dovetail shape of the interlocking portion 105a of the flexible layer 105 is configured in such a way that a protruding portion protruding into an interior of the strength layer 104 configures a head portion. The head portion largely expands in the interior of the strength layer 104 via a narrow neck portion. Therefore, when the flexible layer 105 is to be detached from the strength layer 104, the largely expanded head portion of the dovetail shape serves as a wedge to form a mechanical coupling which physically prevents a decoupling therebetween. Shapes other than the dovetail shape may be employed, as long as the flexible layer 105 and the strength layer 104 are interlocking to each other and thus difficult to be decoupled from each other.

For the composite structural member 101 having a configuration mentioned above, in a related art, a strength layer which uses a thermosetting resin as a base material is provided on a flexible layer which is bonded to a back surface of the metal panel and uses a thermoplastic resin as a base material. However, in such a related art, the thermosetting resin is used in the strength layer and thus a molding process is difficult to perform. Accordingly, handling at the time of molding was difficult. Further, in a case where the metal panel constitutes a door panel or quarter panel of a vehicle, baking of paint is essentially required in a painting process of the metal panel. Accordingly, a heating process (for baking of paint) is followed after the metal panel is reinforced with the resin member. In above related art, when a heating process for baking of paint is performed after the metal panel is reinforced with the resin member, due to the heating, the strength layer is cured because a thermosetting resin is used as a base material, but the flexible layer is softened because a thermoplastic resin is used as a base material. As a result, there is a problem that (tensile) load occurs in the joint interface of the strength layer and the flexible layer and thus the strength layer and flexible layer are easily decoupled from each other.

Here, in order to solve the problem that (tensile) load occurs in the joint interface of the strength layer and the flexible layer and thus the strength layer and flexible layer are easily decoupled from each other, it is also considered that both the strength layer and the flexible layer use a thermosetting resin as a base material. In this case, when a heating process for baking of paint is performed after the resin member is adhered to the metal panel, changes of the strength layer and the flexible layer due to heating and cooling are the same because both the strength layer and the flexible layer of the resin member are made of a thermosetting resin. Consequently, (tensile) load is less likely to occur in the joint interface of the strength layer and the flexible layer and therefore the strength layer and the flexible layer are less likely to be decoupled from each other. However, in this case, since the thermosetting resin is directly bonded to the metal panel, it is difficult to solve a conventional problem which was caused in the case of using the resin member as a reinforcing member for the metal panel, that is, a problem that deformation occurs in the surface of the metal panel because the resin member is expanded by heating by following-up heating process for baking of paint and is contracted at the time of being cooled. In this regard, according to the present embodiment, the elongated resin members 103 are adhered to the metal panel 102 used in the composite structural member 101 and include the strength layer 104 which is made of a glass fiber reinforced resin mixed with a thermoplastic resin and the flexible layer 105 which is laminated and bonded to the strength layer 104. Here, the flexible layer 105 is made of a thermoplastic resin that is more flexible than the strength layer 104. Further, the flexible layer 105 is brought into contact with the metal panel 102 when the resin members 103 are adhered to the metal panel 102.

According to the composite structural member 101 thus configured, the following effects can be achieved. In the present embodiment, since both the strength layer 104 and the flexible layer 105 of the resin member 106 are made of a glass fiber reinforced resin mixed with a thermoplastic resin or a thermoplastic elastomer and a thermosetting resin is not used, handling at the time of molding is easy. Further, in a case where a heating process for baking of paint is performed after the resin member 103 is adhered to the metal panel 102, both the strength layer 104 and the flexible layer 105 are softened and expanded due to heating and softened and contracted due to cooling since both the strength layer 104 and the flexible layer 105 of the resin member 103 are made of a glass fiber reinforced resin mixed with a thermoplastic resin or a thermoplastic elastomer. As a result, (tensile) load is less likely to occur in the joint interface of the strength layer 104 and the flexible layer 105 and therefore the strength layer 104 and the flexible layer 105 are less likely to be decoupled from each other.

Since the flexible layer 105 of the resin member 103 includes the interlocking portion 105a which interlocks with the strength layer 104, the flexible layer 105 and the strength layer 104 are interlocking to each other. Accordingly, a differential shrinkage during curing shrinkage of the strength layer 104 to which the flexible layer 105 is interlocking and the flexible layer 105, which is caused due to cooling after the heating process for baking of paint is reduced. In addition, since contact area between the strength layer 104 and the flexible layer 105 increases, the strength layer 104 and the flexible layer 105 are further less likely to be decoupled from each other. In particular, since the interlocking portion 105a of the flexible layer 105 interlocking to the strength layer 104 is formed in a dovetail shape and a mechanical coupling for preventing a decoupling of the strength layer and the flexible layer is provided, the strength layer 104 and the flexible layer 105 are less likely to be decoupled from each other.

Hereinafter, evaluation was performed to confirm the effect that the strength layer 104 and the flexible layer 105 are less likely to be decoupled from each other since the interlocking portion 105a of the flexible layer 105 interlocking with the strength layer 104 is formed in a dovetail shape.

FIG. 8 (a) is a sectional view of a resin member 103 according to the third embodiment and FIG. 8 (b) is a sectional view of a resin member according to a modified embodiment included in the present invention. As illustrated in FIG. 8(b), in the modified embodiment, there is no interlocking portion like the embodiment and the strength layer and the flexible layer are joined in a flat surface in a cross section perpendicular to the longitudinal direction of the resin member. Configuration (for example, material) of the resin member other than the interlocking portion is the same in the third embodiment and the modified embodiment.

### Test Method

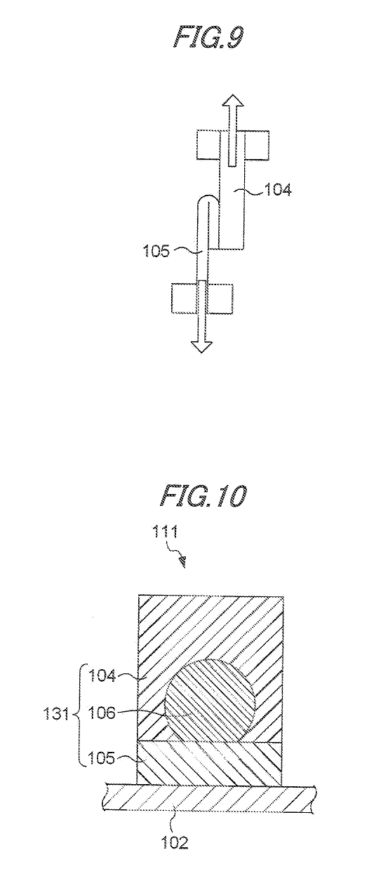

FIG. 9 is a view illustrating a method of peel test (according to JISK6854). As illustrated in FIG. 9, first, the strength layer 104 and the flexible layer 105 are partially decoupled and then pulled apart from each other. And, a tensile force was measured at the time when the strength layer and the flexible layer are further decoupled.

### Result

As a result, it was found that the resin member 103 of the third embodiment has a bonding strength of 2.5 times as compared to the modified embodiment. That is, it was apparent that the strength layer 104 and the flexible layer 105 are less likely to be decoupled from each other when the interlocking portion 105a of the flexible layer 105 interlocking to the strength layer 104 is formed in a dovetail shape to give mechanical coupling.

Further, in the present embodiment, since the interlocking portion 105a of the flexible layer 105 interlocking into the strength layer 104 in the resin member 103 has a high thermal conductivity, the interior of the strength layer 104 is easily cooled by a cooling process after the heating process for baking of paint. Accordingly, it is possible to suppress warpage of the resin member 103 which was caused in a case where only the outside of the strength layer 104 is cooled and thus differential shrinkage in the interior and the outside of the strength layer 104 during curing shrinkage is large. Thereby, high bonding strength between the strength layer 104 and the flexible layer 105 or between the resin member 103 and the metal panel 102 can be maintained.

A manufacturing method of the composite structural member of the third embodiment includes a process (hereinafter, referred to as “first process”) for obtaining the resin member 103 and a process (hereinafter, referred to as “second process”) for bonding the resin member 103 to the metal panel 102.

In the first process, two kinds of resin of a reinforcing resin used as a material of the strength layer 104 and a thermoplastic elastomer used as a material of the flexible layer 105 is supplied to an extruder (not-illustrated) and extruded at high-temperature to integrally form an elongated material. Thereby, the strength layer 104 and the flexible layer 105 are coupled to integrally form the resin member 103. At this time, the interlocking portion 105a of the flexible layer 105 interlocking into the strength layer 104 is formed in a dovetail shape, in a cross section perpendicular to the longitudinal direction of the resin member 103.

In the second process, the resin member 103 obtained in the first process is heated and bonded to the metal panel 102 by adhesion. Specifically, a plurality of elongated resin members 103 are bonded to the back surface of the metal panel 102 with a predetermined interval by adhesion. Thereby, the composite structural member 101 is obtained. According to the third embodiment, it is possible to manufacture the composite structural member 101 in which handling at the time of molding is easy and the strength layer 104 and the flexible layer 105 are less likely to be decoupled from each other.

The composite structural member 101 may be manufactured by coupling the resin member 103 of the third embodiment and the metal panel 102 using the apparatus·method of the first embodiment or the second embodiment.

### Fourth Embodiment

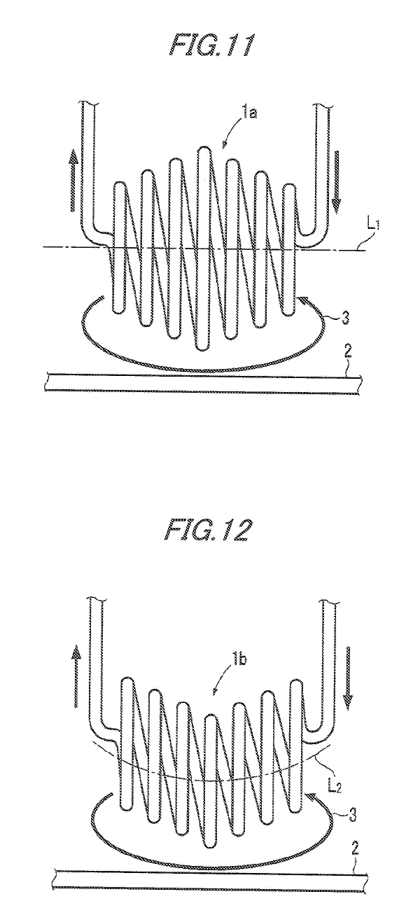

A configuration of a composite structural member 111 according to a fourth embodiment will be described by referring to FIG. 10. In the description of the fourth embodiment, only characteristic parts thereof will be described and description relating to a part which is described in the third embodiment will be omitted. FIG. 10 is a section view of the composite structural member 111 according to the fourth embodiment. As illustrated in FIG. 10, a resin member 131 includes the strength layer 104, the flexible layer 105 which is brought into contact with the metal panel 102 when the resin members 131 are adhered to the metal panel 102 and a second flexible layer 106 as a third layer which is brought into contact with the flexible layer 105 in the interior of the strength layer 104, in a cross section perpendicular to the longitudinal direction thereof. The second flexible layer 106 of the resin member 131 uses a base material such as a thermoplastic elastomer. As the base material, a thermoplastic resin is used, which is more flexible than the strength layer 104 and has a high thermal conductivity. The conductivity of the second flexible layer 106 may be higher than that of the flexible layer 105. The third layer of the resin member 131 is not limited to the second flexible layer 106. For example, the third layer may be an air layer, etc.

According to the composite structural member 111 of the fourth embodiment, the following effects can be achieved. Since the strength layer 104 is provided at its interior with the second flexible layer 106 which is brought into contact with the flexible layer 105 and has higher thermal conductivity than the strength layer, the second flexible layer 106 and the strength layer 104 provided outside the second flexible layer are easy to be cooled integrally by a cooling process after the heating process for baking of paint. Accordingly, it is possible to suppress warpage of the resin member 131 which was caused in a case where only the outside of the strength layer 104 is cooled and thus differential shrinkage in the interior and the outside of the strength layer 104 during curing shrinkage is large. Thereby, high bonding strength between the strength layer 104 and the flexible layer 105 or between the resin member 131 and the metal panel 102 can be maintained.

The composite structural member 111 may be manufactured by coupling the resin member 131 of the fourth embodiment and the metal panel 102 using the apparatus·method of the first embodiment or the second embodiment. Fifth embodiment to eighth embodiment relate to details of an induction heating apparatus which can be used in the manufacturing apparatus of the composite structural member.

### Fifth Embodiment

FIG. 11 is a schematic view illustrating the shape of a coil of a fifth embodiment. A coil 1a is arranged with respect to a heated body 2 (plate) in such a way that an axis L1 of the coil 1a extends along a heated surface of the heated body 2. Then, when current is supplied to the coil 1a in a direction of arrow, magnetic flux 3 occurs in a direction substantially horizontal to the heated body 2.

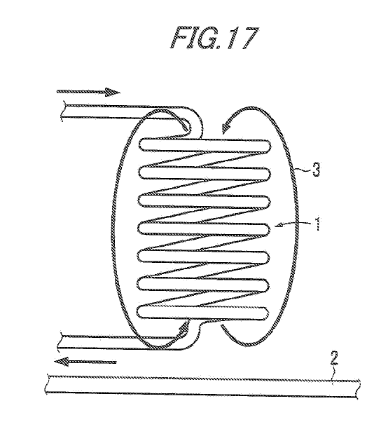

In a related art, the coil is arranged so that magnetic flux 3 occurs in a direction substantially perpendicular to the heated body 2 when current flows into the coil 1 in a direction indicated by an arrow, as illustrated in FIG. 17. Since the flow of the magnetic flux 3 becomes a reverse direction in the center portion of the coil 1 when the coil 1 is arranged as mentioned above, amount of heat generated in the center portion is smaller as compared to a peripheral portion of the coil. As a result, the peripheral portion of the coil becomes high-temperature and thus temperature difference between the peripheral portion and non-heated portion outside the coil becomes larger.

However, since the flow direction of the magnetic flux 3 in the center part of the coil does not change when the coil 1a is arranged as in the fifth embodiment, the temperature in a part of the heated body 2 opposing to the coil 1a becomes uniform.

Further, the coil 1a is shaped to have a center convex portion so that the center portion of the coil is close to the heated body 2. Since the center portion of the coil 1a is most close to the heated body 2, it is possible to heat the heated body 2 to the highest temperature near the center portion of the coil 1a.

And, since the coil is gradually spaced apart from the heated body 2 toward both ends of the coil, it is possible to reduce amount of heat which is given to the heated body 2.

Accordingly, since the temperature of the heated body 2 can be raised in an even and gradual temperature gradient even when a thermoplastic resin is fused as a reinforcing member, it is possible to suppress occurrence of deformation.

### Sixth Embodiment

FIG. 12 is a schematic view illustrating the shape of a coil of a sixth embodiment. A coil 1b is wound in a curved shape near a center portion thereof and arranged to be close to the heated body 2 in the center portion thereof.

By employing such a coil shape, the center portion of the coil is the closest to the heated body 2 and therefore it is possible to heat the heated body to the highest temperature near the center portion of the coil. cl Seventh Embodiment

Next, a method for adjusting the heating temperature by changing the magnetic flux density will be described. In induction heating, as the magnetic flux density becomes larger, the heating temperature becomes higher. Amount of heat given to the heated body 2 can be adjusted using the property of this induction heating and thus the heated body can be heated in a gradual temperature gradient.

FIG. 13 is a schematic view illustrating the shape of a coil of the seventh embodiment. As a thin wire is utilized as a conductive wire used, it is possible to increase the magnetic flux density of the coil. Accordingly, by using a coil 1c which has variable cross-sectional area, the magnetic flux density is changed and therefore it is possible to adjust the temperature gradient.

As illustrated in FIG. 13, it is preferable that the diameter D1 of an electric conductor in the center portion of the coil 1c is the smallest and the diameter Dn gradually increases toward both ends thereof. When the diameter of the electric conductor is such that Dn>D1, the temperature gradient can be set so that the cross-sectional area is the narrowest and thus temperature increases in the center portion of the coil.

Herein, an example where the cross-sectional area of the coil is adjusted by changing the diameter of the electric conductor is illustrated. However, the electric conductor may have any cross-sectional shape, as long as the cross-sectional area in the center portion of the coil can be minimized.

### Eighth Embodiment

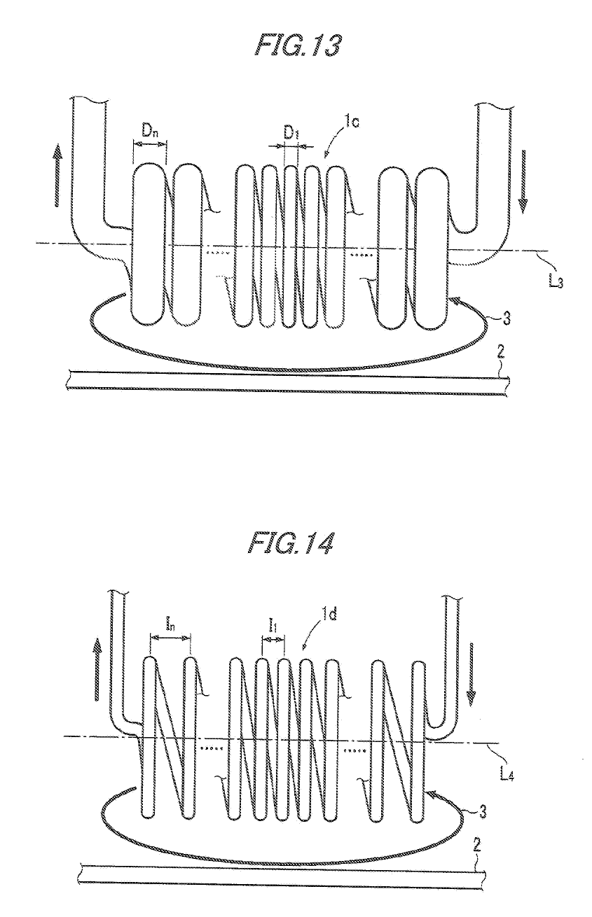

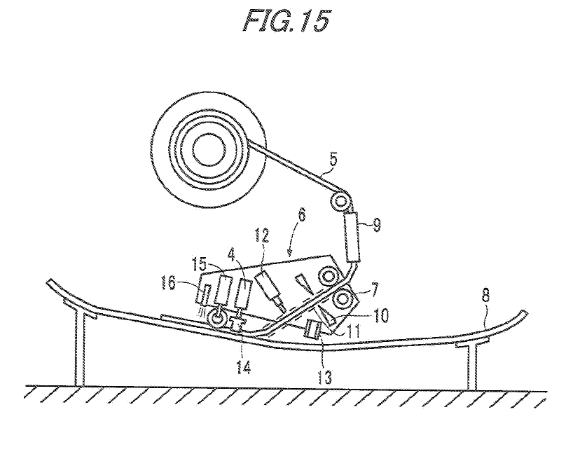

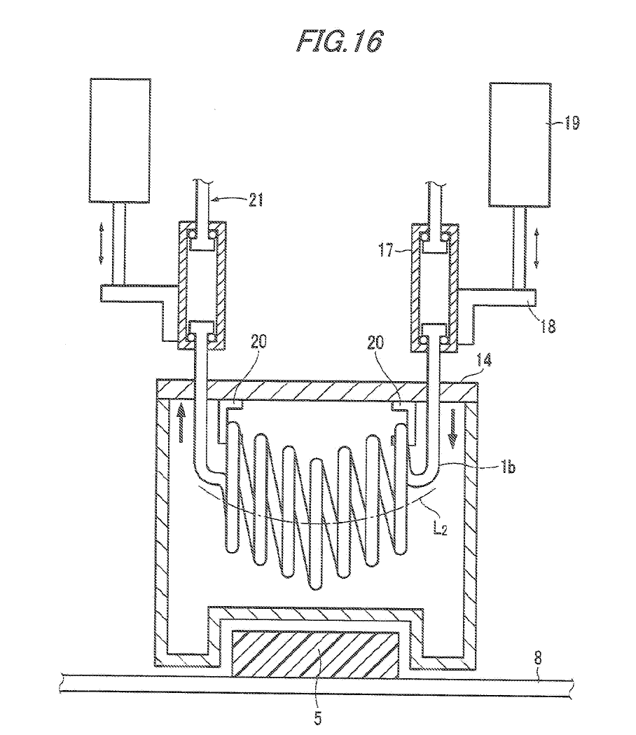

FIG. 14 is a schematic view illustrating the shape of a coil of an eighth embodiment. This is intended to adjust the magnetic flux density by the winding density of a coil 1d. Preferably, the coil is wound so that gaps I1 between the electric conductors in the center portion of the coil are sparse toward both ends of the coil. That is, it is possible to increase the temperature in the center portion of the coil to the highest by winding the coil so that in>I1.

By employing such a coil shape, it is possible to heat the heated body in a temperature gradient in which the temperature in the center portion of the coil is the highest and the temperature is slowly lowered toward both ends thereof.

It is also possible to apply a combination of the shapes of the fifth embodiment to eighth embodiment. For example, it is also possible to adjust the temperature by a coil which is obtained by combining the coil shape of the fifth embodiment or sixth embodiment in which the center portion of the coil is close to the heated body and the coil shape of the seventh embodiment or eighth embodiment in which the temperature gradient is regulated by adjusting the magnetic flux density.

FIG. 15 illustrates a manufacturing apparatus of a composite structural member that is made of a plate such as a metal panel and a thermoplastic resin reinforcing member using the induction heating apparatus 4 of the fifth embodiment to the eighth embodiment.

As illustrated in FIG. 15, the weld-adhesive resin 5 which is a reinforcing member is continuously fed by a feeding roller 7 within the weld-adhesion tool 6. The weld-adhesion tool 6 is coupled to a robot (not-illustrated) and adapted to move over a metal panel 8 (plate) which is reinforced by the weld-adhesive resin 5. That is, it is possible to reinforce any area on the metal panel 8 by the weld-adhesive resin 5 by moving the weld-adhesion tool 6 itself.

The weld-adhesive resin 5 may be preheated by a heat-transfer heater tube 9 while being continuously fed before being inserted into the weld-adhesion tool 6.

The weld-adhesive resin 5 fed into the weld-adhesion tool 6 is cut to any length by a cutting part 10 and then inserted into a warm air heating guide 11 to be finally heated by a hot-air generating device 12 for generating a hot-air.

Meanwhile, the metal panel 8 is a reinforced member and a part of the metal panel on which resin is adhered is degreased and washed by atmospheric-pressure plasma generated by an atmospheric-pressure plasma generation device 13. By such a degreasing and washing operation, the weld-adhesive resin 5 is securely in close contact with the metal panel and therefore it is possible to suppress occurrence of an area to which the weld-adhesive resin 5 is not adhered. Accordingly, adhesive force is enhanced and thus it is possible to perform stable adhesion.

And, the metal panel 8 is reinforced by adhesion with the weld-adhesive resin 5 while being heated by an induction heating apparatus 4.

The coil 1b of dielectric heating device mentioned above is embedded in a pressing cover 14 of the induction heating apparatus 4 and current is supplied to the coil. By forming the pressing cover 14 from insulation material such as ceramic, resin or the like and performing a pressure control, the surface of the metal panel 8 to which the weld-adhesive resin 5 is adhered can be pressed while being heated. The weld-adhesive resin after being pressed by the induction heating apparatus 4 is securely attached by a pressing roller 15 having L-guide and cooled by a cooling air generating device 16. In this way, the attachment operation is completed.

FIG. 16 is a schematic view illustrating a state where a pressing part of the induction heating apparatus 4 illustrated in FIG. 15 is partially enlarged and partially cut-out.

The coil 1b employs a coil shape of which a center portion becomes high-temperature. Although the coil shape of the sixth embodiment is illustratively utilized in FIG. 16, a coil in any other shape may be used, as long as a center portion becomes high-temperature.

Both ends of the coil 1b are connected to a copper stroke guide 17 and connected to a servo motor 19 via an insulation bracket 18.

The coil 1b is accommodated in the pressing cover 14 below the copper stroke guide 17. And, the coil 1b is positioned in an upper inner wall of the pressing cover 14 by fixing plates 20. The fixing plates are respectively made of insulator at an outermost location of the winding portion.

Both ends of the coil 1b are connected to the servo motor 19 via the insulation bracket 18 at the outside of the pressing cover 14, as mentioned above. And, the servo motor 19 thus connected can lift the coil lb itself in a vertical direction by pulling both ends of the coil 1b.

By such a configuration, the both ends of the coil 1b are lifted in a vertical direction by the servo motor 19 to follow the shape of the metal panel 8 and thus the position of the coil 1b can be displaced in a vertical direction. In this way, since the position of the coil 1b can be displaced in a vertical direction relative to the metal panel 8, a fine temperature control becomes possible.

Herein, although the servo motor 19 is illustratively represented as a driving source of a lifting mechanism for the coil 1b, any driving mechanism which is capable of lifting a portion of the coil 1b in a vertical direction may be used.

Further, the coil 1b is connected to a lead 21 via the copper stroke guide 17. Current flows through the coil 1b from the lead 21 via the copper stroke guide 17. The copper stroke guide 17 is designed in a hollow shape and a coolant may flow to the copper stroke guide 17 through a pipe.

By configuring the induction heating apparatus 4 to include the lifting mechanism as described in the above, the distance between the metal panel 8 and the coil can be kept constant. Accordingly, the temperature of the metal panel 8 can be uniformly raised. In this way, there is no case where thermal strain occurs due to thermal expansion, even in a case of using a thin steel plate. Thereby, it is possible to form a gradual temperature gradient.

As such, when the induction heating apparatus 4 of the fifth embodiment to the eighth embodiment is used in the heating process of the metal panel 8, the temperature of the metal panel 8 can be raised in an even and gradual temperature gradient. Accordingly, it is possible to suppress occurrence of deformation.

Of course, the induction heating apparatus 4 of the fifth embodiment to the eighth embodiment may be used in the composite structural member manufacturing apparatus of the first embodiment to the fourth embodiment.

According to the embodiments and modified embodiment mentioned above, the manufacturing apparatus of a composite structural member which is made of a plate and a thermoplastic resin reinforcing member may include a material supply part for continuously supplying the reinforcing member, a cutting part for cutting the reinforcing member to any length, a heating part for heating the reinforcing member and a pressing part for pressing the heated reinforcing member to the plate.

Further, according to the embodiments and modified embodiment mentioned above, the manufacturing method of a composite structural member which is made of a plate and a thermoplastic resin reinforcing member may include a process for continuously supplying the reinforcing member, a process for cutting the reinforcing member to any length, a process for heating the reinforcing member and a process for pressing the heated reinforcing member to the plate.

According to the manufacturing apparatus and method mentioned above, even in case where a reinforcing member having a complex configuration is used, since the reinforcing member uses a thermoplastic resin which is generated in advance and is cut to any length while maintaining the rigidity without damaging the shape of the reinforcing member, it is possible to form the composite structural member by a simple mechanism without reducing the molding speed.

Further, even in a case where a resin material having a complex shape is used as the reinforcing member, the resin material is molded in advance and therefore the time for molding the resin material in not necessary. Accordingly, it is possible to shorten the manufacturing time. Further, the manufacturing apparatus itself does not require a mechanism for molding the resin material and therefore a simple mechanism can be used.

The temperature of the plate may be raised before the reinforcing member is pressed to the plate. By this configuration, it is possible to increase the bonding force between the reinforcing member and the plate.

Further, if the plate is made of a metal material, in the process for raising the temperature of the plate, the temperature of the plate may be raised by induction heating. By this configuration, since only the plate of the metal material which is a magnetic body can be heated, it is possible to increase the bonding force between the reinforcing member made of a thermoplastic resin and the plate made of a metal material.

In the process for raising the temperature of the plate by the induction heating, the plate may be inductively heated while a positioning device that is configured with an electrically insulating material is brought into contact with the reinforcing member. In this case, since the plate of the metal material can be directly heated while positioning the reinforcing member, adhesion efficiency between the metal member and the reinforcing member is improved. Further, since the distance between the metal member and the induction heating apparatus can be kept constant, it is possible to raise the temperature of the plate of the metal material in a stable manner and thus to strongly adhere the reinforcing member to the plate.

Further, according to the embodiments and modified embodiment mentioned above, reinforcing members (for example, resin members 103, 131 which will be described later) may be elongated resin members which are adhered to a plate (for example, metal panel 102 which will be described later) and include a strength layer (for example, strength layer 104 which will be described later) made of a thermoplastic resin or a reinforcing resin which is made of a mixture of a thermoplastic resin and a reinforcing material and a flexible layer (for example, flexible layer 105 which will be described later) which is laminated and bonded to the strength layer. Here, the flexible layer is made of a thermoplastic resin which is more flexible than the strength layer and is brought into contact with the plate when the resin members are adhered to the plate.

According to the above configuration, since both the strength layer and the flexible layer of the reinforcing member are made of a thermoplastic resin or a reinforcing resin mixed with a thermoplastic resin and a thermosetting resin is not used, handling at the time of molding is easy. Further, in a case where a heating process (for baking of paint, for example) is performed after the reinforcing member is adhered to the plate, both the strength layer and the flexible layer are softened and expanded due to heating and softened and contracted due to cooling since both the strength layer and the flexible layer of the resin member are made of a thermoplastic resin or a reinforcing resin mixed with a thermoplastic resin. As a result, (tensile) load is less likely to occur in the joint interface of the strength layer and the flexible layer and therefore the strength layer and the flexible layer are less likely to be decoupled from each other.

The flexible layer and the strength layer may be interlocking with each other in a cross section perpendicular to a longitudinal direction of the resin member.

Since the flexible layer interlocks to the strength layer, differential shrinkage during curing shrinkage of the strength layer and the flexible layer, which is caused due to cooling after the heating process, is reduced, and the contact area between the strength layer and the flexible layer increases, the strength layer and the flexible layer are less likely to be decoupled from each other.

A portion (for example, the interlocking portion 105a which will be described later) of the flexible layer interlocking to the strength layer may be formed in a dovetail shape, in a cross section perpendicular to the longitudinal direction of the resin member.

Since the dovetail shape forms a mechanical coupling for preventing a decoupling of the strength layer and the flexible layer, the strength layer and the flexible layer are less likely to be decoupled from each other.

The conductivity of the flexible layer may be higher than that of the strength layer.

According to the above configuration, since the interlocking portion of the flexible layer interlocking to the strength layer has a high thermal conductivity, the interior of the strength layer is easily cooled by a cooling process after the heating process. Accordingly, it is possible to suppress warpage of the resin member which was caused in a case where only the outside of the strength layer is cooled and thus differential shrinkage in the interior and the outside of the strength layer during curing shrinkage is large. Thereby, high bonding strength between the strength layer and the flexible layer or between the resin member and the metal panel can be maintained.

A third layer (for example, second flexible layer 106 which will be described later) may be provided in the interior of the strength layer, in a cross section perpendicular to the longitudinal direction of the resin member. The third layer is brought into contact with the flexible layer and has thermal conductivity higher than the strength layer.

According to the above configuration, since the third layer which is brought into contact with the flexible layer and has thermal conductivity higher than the strength layer is provided in the interior of the strength layer, the third layer and the strength layer at the outside thereof are easy to be cooled integrally by a cooling process after the heating process. Accordingly, it is possible to suppress warpage of the resin member which was caused in a case where only the outside of the strength layer is cooled and thus differential shrinkage in the interior and the outside of the strength layer during curing shrinkage is large. Thereby, high bonding strength between the strength layer and the flexible layer or between the resin member and the metal panel can be maintained.

Further, according to the embodiments and modified embodiment mentioned above, the manufacturing apparatus may include a coil which is formed by winding the electric conductor to inductively heat the heated body and the coil may be arranged so that an axis of the coli extends along a heated surface of the heated body.

By arranging the coil with respect to the heated body in such a way that an axis of the coil in the center of the coil extends relative to a heated surface of the heated body, the magnetic flux lines occur to extend along a heated surface of the heated body.

Since induction heating is adapted to heat the heated body by inducing current to the heated body by electromagnetic induction, induction heating has a property that the heated body is heated along the magnetic flux lines. In this configuration, since the magnetic flux lines occur to extend along a heated surface of the heated body, temperature distribution in the heated surface is not lowered near the center portion thereof and a portion of the heated body opposing to the coil has a uniform temperature distribution.

If it is possible to design the shape and arrangement of the coil so that the center portion of the coil becomes the highest temperature, a temperature difference between the heated body and a non-heated part becomes small and therefore the heated body can be heated in a gradual temperature gradient.

For this purpose, the shape of the coil may be designed in such a way that the center portion of the coil is most close to the heated body and the coil is spaced apart from the heated body toward both ends of the coil.

According to this configuration, since the coil is wound so that a center portion of the coil is close to the heated body, the temperature rises near the center portion rises and is lowered at both ends of the coil. As a result, a gradual temperature gradient is obtained. In this way, since a temperature difference between a heated part and a non-heated part becomes small, thermal strain is not likely to occur. Consequently, the thermal strain does not occur in the metal and therefore it is possible to suppress deformation, even when the resin material is bonded to a thin steel plate.

Further, the coil may be configured so that the cross-sectional area of the electric conductor is narrowed at the center portion and is widen from the center portion toward both ends of the coil.

In induction heating, as the magnetic flux density becomes larger, the heating temperature becomes higher. Accordingly, by adapting a coil shape so that the magnetic flux density increases near the center portion of the coil, the heating temperature can be set to be higher at the center portion of the coil and to be lower at both ends of the coil. As a result, it is possible to reduce temperature difference between a heated part and a non-heated part.

Since the magnetic flux density becomes higher as a cross-sectional area of electric conductor becomes narrower, a coil in which a cross-sectional area becomes smaller toward a center portion of the coil may be used.

Further, the coil may be wound so that the electric conductors are dense at a center portion of the coil and are sparse from the center portion toward both ends of the coil.

Since the magnetic flux density can be adjusted by the winding density of the coil, it is possible to adjust heating temperature by adjusting a coil density.

Since the magnetic flux density becomes higher as gaps between the electric conductors become denser, it is possible to increase amount of heat given to the heated body. Accordingly, a desired temperature distribution can be obtained by winding the coil while adjusting the gaps between the electric conductors of the coil.

Furthermore, the manufacturing apparatus may include a lifting mechanism for lifting an end of the induction heating apparatus in a vertical direction relative to the heated body.

In addition to the temperature adjusting function by the coil shape mentioned above, it is possible to further adjust the distance between the coil and the heated body by providing the lifting mechanism for lifting the coil itself in a vertical direction. Accordingly, a fine temperature control along the heated body becomes possible.

What is claimed is:

1. A manufacturing apparatus of a composite structural member which is made of a plate and a thermoplastic resin reinforcing member, the apparatus comprising:
a material supply part that continuously supplies the reinforcing member;
a cutting part that cuts the reinforcing member;
a heating part that heats the reinforcing member; and
a pressing part that presses the heated reinforcing member to the plate.

2. The manufacturing apparatus according to claim 1, further comprising:
a temperature rising part that rises a temperature of the plate before the reinforcing member is pressed to the plate.

3. The manufacturing apparatus according to claim 2, wherein the plate is made of a metal material, and
wherein the temperature rising part comprises an induction heating part adapted to rise the temperature of the plate.

4. The manufacturing apparatus according to claim 3, wherein the induction heating part includes a positioning device made of an electrically insulating material.

5. The manufacturing apparatus according to claim 1, wherein the reinforcing member includes:
a strength layer made of a thermoplastic resin or a reinforcing resin which is made of a mixture of a thermoplastic resin and a reinforcing material; and
a flexible layer which is laminated and bonded to the strength layer, wherein the flexible layer is made of a thermoplastic resin which is more flexible than the strength layer and brought into contact with the plate when the resin members are adhered to the plate.

6. The manufacturing apparatus according to claim 5, wherein the flexible layer and the strength layer are interlocking to each other in a cross section perpendicular to a longitudinal direction of the reinforcing member.

7. The manufacturing apparatus according to claim 6, wherein a portion of the flexible layer interlocking into the strength layer has a dovetail shape in the cross section perpendicular to the longitudinal direction of the reinforcing member.

8. The manufacturing apparatus according to claim 7, wherein a thermal conductivity of the flexible layer is higher than a thermal conductivity of the strength layer.

9. The manufacturing apparatus according to claim 5, wherein the reinforcing member includes a third layer which is provided in an interior of the strength layer,
wherein the third layer is brought into contact with the flexible layer in the cross section perpendicular to the longitudinal direction of the reinforcing member, and
wherein a thermal conductivity of the third layer is higher than a thermal conductivity of the strength layer.

10. The manufacturing apparatus according to claim 3, wherein the induction heating part includes a coil which is formed by winding the electric conductor to inductively heat the plate, and
wherein the coil is arranged so that an axis of the coil extends along a heated surface of the plate.

11. The manufacturing apparatus according to claim 10, wherein the coil is wound so that a center portion of the coil is the closest to the plate and a surface of the coil opposing to the plate is spaced apart from the place toward both ends of the coil.

12. The manufacturing apparatus according to claim 10, wherein a cross-sectional area of the electric conductor of the coil is narrowed at a center portion of the coil and is widen from the center portion toward both ends of the coil.

13. The manufacturing apparatus according to claim 10, wherein the coil is wound so that the electric conductors are dense at a center portion of the coil and are sparse from the center portion toward both ends of the coil.

14. The manufacturing apparatus according to claim 10, further comprising:
a lifting mechanism that lifts an end of the induction heating part in a vertical direction relative to the plate.

15. A manufacturing method of a composite structural member which is made of a plate and a thermoplastic resin reinforcing member, the method comprising:
continuously supplying the reinforcing member;
cutting the reinforcing member;
heating the reinforcing member; and
pressing the heated reinforcing member to the plate.

16. The manufacturing method according to claim 15, further comprising:
raising a temperature of the plate before pressing the reinforcing member to the plate.

17. The manufacturing method according to claim 16, wherein the plate is made of a metal material, and
wherein the temperature of the plate is raised by an induction heating, during raising the temperature of the plate.

18. The manufacturing method according to claim 17, wherein, during raising the temperature of the plate by the induction heating, the plate is inductively heated while a positioning device configured with an electrically insulating material is brought into contact with the reinforcing member.

19. The manufacturing method according to claim 15, wherein the reinforcing member includes a strength layer made of a thermoplastic resin or a reinforcing resin which is made of a mixture of a thermoplastic resin and a reinforcing material and a flexible layer made of a thermoplastic resin which is more flexible than the strength layer, and
wherein the manufacturing method further comprising:
forming the reinforcing member by coupling the strength layer and the flexible layer; and
pressing the flexible layer of the reinforcing member to the plate.

20. A composite structural member comprising:
a plate; and,
a reinforcing member,
wherein the reinforcing member includes:
a strength layer made of a thermoplastic resin or a reinforcing resin which is made of a mixture of a thermoplastic resin and a reinforcing material; and
a flexible layer which is laminated and bonded to the strength layer, the flexible layer being made of a thermoplastic resin which is more flexible than the strength layer and brought into contact with the plate when the resin members are adhered to the plate, and
wherein the flexible layer and the strength layer are interlocking to each other in a cross section perpendicular to a longitudinal direction of the reinforcing member.
